(19) United States
(12) Patent Application Publication
(10) Pub. No.: US 2026/0313547 A1
(43) Pub. Date: Oct. 8, 2026

(54) OVERLAID SYNCHRONIZATION SIGNAL BLOCK FOR LOW POWER-SYNCHRONIZATION SIGNAL

(71) Applicant: QUALCOMM Incorporated, San Diego, CA (US)

(72) Inventors: Weimin DUAN, San Diego, CA (US); Huilin XU, Temecula, CA (US); Jing LEI, San Diego, CA (US)

(21) Appl. No.: 19/171,973

(22) Filed: Apr. 7, 2025

(51) Int. Cl. H04W 52/02; H04L 5/00; H04L 27/26

(52) U.S. Cl. CPC H04W 52/0235; H04L 5/0048; H04L 27/2653

(57) ABSTRACT

This disclosure provides methods, components, devices and systems for overlaid synchronization signal block for low power-synchronization signal. For example, a user equipment (UE) may receive, from a network entity, a first portion of a signal that is overlaid with a first set of on-off keying (OOK) on symbols of a low power-synchronization signal (LP-SS), the first portion of the signal being associated with synchronization, channel measurement, or both. The UE may receive, from the network entity, a second portion of the signal that is overlaid with a second set of OOK on symbols of the LP-SS, wherein the first portion of the signal, the second portion of the signal, or both, comprise a synchronization signal block (SSB) signal. The UE may communicate one or more messages with the network entity based at least in part on the SSB signal.

### TECHNICAL FIELD

This disclosure relates generally to wireless communication, and more specifically to systems, devices, methods, and techniques associated with overlaid synchronization signal block for low power-synchronization signal.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving, from a network entity, a first portion of a signal that is overlaid with a first set of on-off keying (OOK) on symbols of a low power-synchronization signal (LP-SS), the first portion of the signal being associated with synchronization, channel measurement, or both, receiving, from the network entity, a second portion of the signal that is overlaid with a second set of OOK on symbols of the LP-SS, where the first portion of the signal, the second portion of the signal, or both, include a synchronization signal block (SSB) signal, and communicating one or more messages with the network entity based on the SSB signal.

A UE for wireless communications is described. The UE may include a processing system that includes processor circuitry and memory circuitry that stores code. The processing system may be configured to cause the UE to receive, from a network entity, a first portion of a signal that is overlaid with a first set of OOK on symbols of a LP-SS, the first portion of the signal being associated with synchronization, channel measurement, or both, receive, from the network entity, a second portion of the signal that is overlaid with a second set of OOK on symbols of the LP-SS, where the first portion of the signal, the second portion of the signal, or both, include a SSB signal, and communicate one or more messages with the network entity based on the SSB signal.

Another UE for wireless communications is described. The UE may include means for receiving, from a network entity, a first portion of a signal that is overlaid with a first set of OOK on symbols of a LP-SS, the first portion of the signal being associated with synchronization, channel measurement, or both, means for receiving, from the network entity, a second portion of the signal that is overlaid with a second set of OOK on symbols of the LP-SS, where the first portion of the signal, the second portion of the signal, or both, include a SSB signal, and means for communicating one or more messages with the network entity based on the SSB signal.

A non-transitory computer-readable medium storing code for wireless communications is described. The code may include instructions executable by one or more processors to receive, from a network entity, a first portion of a signal that is overlaid with a first set of OOK on symbols of a LP-SS, the first portion of the signal being associated with synchronization, channel measurement, or both, receive, from the network entity, a second portion of the signal that is overlaid with a second set of OOK on symbols of the LP-SS, where the first portion of the signal, the second portion of the signal, or both, include a SSB signal, and communicate one or more messages with the network entity based on the SSB signal.

Some examples of the method, user equipment (UEs), and non-transitory computer-readable medium described herein may further include operations, features, means, or instructions for activating an orthogonal frequency division multiplexing (OFDM) based low power-wakeup radio (LP-WUR) or a main radio of the UE to receive the second portion of the signal based on the first portion of the signal being received by a LP-WUR of the UE.

In some examples of the method, user equipment (UEs), and non-transitory computer-readable medium described herein, an RB size associated with an OFDM symbol spanning multiple OOK on symbols includes a fixed RB size based on at least the second portion of the signal being overlaid with the LP-SS on symbols.

Some examples of the method, user equipment (UEs), and non-transitory computer-readable medium described herein may further include operations, features, means, or instructions for identifying at least one RB associated with the second portion of the signal that does not include the SSB signal and applying an RB utilization scheme based on the identified at least one RB.

A method for wireless communications by a network entity is described. The method may include outputting, to a UE, a first portion of a signal that is overlaid with a first set of OOK on symbols of a LP-SS, the first portion of the signal being associated with synchronization, channel measurement, or both, outputting, to the UE, a second portion of the signal that is overlaid with a second set of OOK on symbols of the LP-SS, where the first portion of the signal, the second portion of the signal, or both, include a SSB signal, and communicating one or more messages with the UE based on the SSB signal.

A network entity for wireless communications is described. The network entity may include a processing system that includes processor circuitry and memory circuitry that stores code. The processing system may be configured to cause the network entity to output, to a UE, a first portion of a signal that is overlaid with a first set of OOK on symbols of a LP-SS, the first portion of the signal being associated with synchronization, channel measurement, or both, output, to the UE, a second portion of the signal that is overlaid with a second set of OOK on symbols of the LP-SS, where the first portion of the signal, the second portion of the signal, or both, include a SSB signal, and communicate one or more messages with the UE based on the SSB signal.

Another network entity for wireless communications is described. The network entity may include means for outputting, to a UE, a first portion of a signal that is overlaid with a first set of OOK on symbols of a LP-SS, the first portion of the signal being associated with synchronization, channel measurement, or both, means for outputting, to the UE, a second portion of the signal that is overlaid with a second set of OOK on symbols of the LP-SS, where the first portion of the signal, the second portion of the signal, or both, include a SSB signal, and means for communicating one or more messages with the UE based on the SSB signal.

A non-transitory computer-readable medium storing code for wireless communications is described. The code may include instructions executable by one or more processors to output, to a UE, a first portion of a signal that is overlaid with a first set of OOK on symbols of a LP-SS, the first portion of the signal being associated with synchronization, channel measurement, or both, output, to the UE, a second portion of the signal that is overlaid with a second set of OOK on symbols of the LP-SS, where the first portion of the signal, the second portion of the signal, or both, include a SSB signal, and communicate one or more messages with the UE based on the SSB signal.

In some examples of the method, network entities, and non-transitory computer-readable medium described herein, the first portion of the signal includes an information sequence and the second portion of the signal includes the SSB signal.

In some examples of the method, network entities, and non-transitory computer-readable medium described herein, the second portion of the signal includes a PBCH portion of the SSB signal in conjunction with one or more PBCH DMRS signals.

In some examples of the method, network entities, and non-transitory computer-readable medium described herein, the first portion of the signal includes one or more signals available for the synchronization, channel measurement, or both, and the second portion of the signal includes the SSB signal.

### BRIEF DESCRIPTION OF THE DRAWINGS

FIG. 1 shows an example of a wireless communication system.

FIG. 2 shows an example of a signaling diagram that supports overlaid synchronization signal block (SSB) for low power-synchronization signal (LP-SS).

FIG. 3 shows an example of a diagram that supports overlaid SSB for LP-SS.

FIG. 4 shows an example of a diagram that supports overlaid SSB for LP-SS.

FIG. 5 shows an example of a diagram that supports overlaid SSB for LP-SS.

FIG. 6 shows an example of a diagram that supports overlaid SSB for LP-SS.

FIG. 7 shows a block diagram of a processing system that supports overlaid SSB for LP-SS.

FIG. 8 shows a diagram of a system including a device that supports overlaid SSB for LP-SS.

FIG. 9 shows a block diagram of a processing system that supports overlaid SSB for LP-SS.

FIG. 10 shows a diagram of a system including a device that supports overlaid SSB for LP-SS.

FIGS. 11 through 13 show flowcharts illustrating methods that support overlaid SSB for LP-SS.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems may utilize various signaling techniques to support wireless communications between user equipment (UE) and the network. Some signaling includes traditional cellular signaling, such as control, management, or data communications exchanged via a main or primary radio of the UE. Other signaling includes low power signaling used to wake up the UE, such as low power-wakeup signaling (LP-WUS) or low power-synchronization signaling (LP-SS). Such low power signaling may allow the UE to use a low power-wakeup radio (LP-WUR) of the UE to conserve power. However, in some cases this may result in duplicate signaling being used, which results in inefficient usage of over-the-air resources as well as increased UE power consumption.

Aspects of the subject matter described in this disclosure relate to a synchronization signal block (SSB) transmission from the network that is overlaid with respect to (e.g., in the time domain) a LP-SS. For example, the overlaid SSB may be transmitted during on-off keying (OOK) symbols of the LP-SS. Accordingly, the UE may transmit (and the network entity may receive) a first portion of a signal that is overlaid with a first set of OOK on symbols of a LP-SS. In some cases, the first portion of the signal may be associated with synchronization, channel measurement, or both. The UE may receive (and the network entity may transmit) a second portion of the signal that is overlaid with a second set of OOK on symbols of the LP-SS. In some cases, the first portion of the signal, the second portion of the signal, or both, may be or otherwise include a SSB signal. The UE and the network entity may communicate message(s) based at least in part on the SSB signal. For example, the UE may perform time synchronization or measurements using the SSB or synchronization sequences overlaid onto the LP-SS as part of a connection (re)establishment procedure to communicate the message(s).

Particular aspects of the subject matter described in this disclosure can be implemented to realize one or more of the following potential advantages. In some examples, by overlaying the SSB with the LP-SS, the described techniques can be used to improve power saving operations for UE and the network. This may further improve UE connectivity by allowing at least partial SSB signal reception by the UE while operating in a low-power mode.

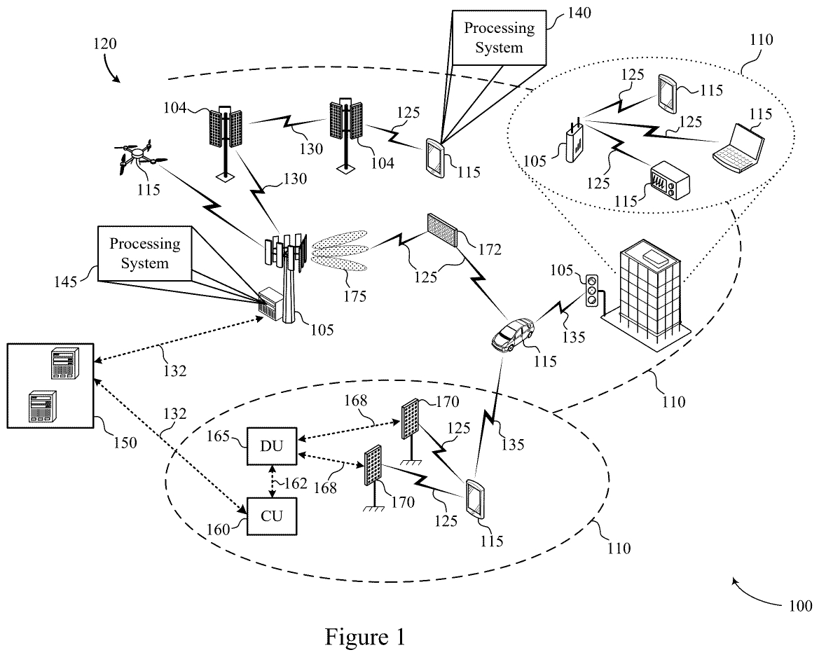

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for overlaid SSB for LP-SS. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support improved power saving operations by the UE 115 based on overlaying a SSB signal with a LP-SS being monitored by the low power UE 115.

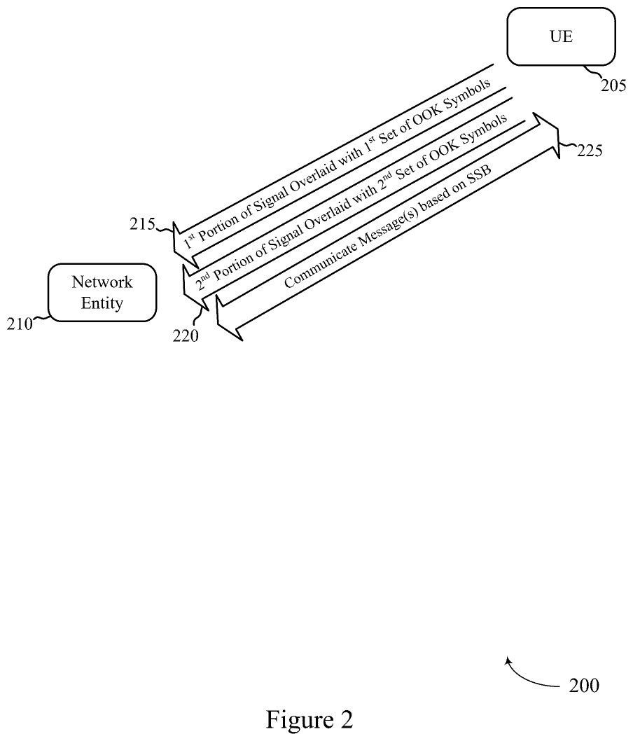

FIG. 2 shows an example of a signaling diagram 200 that supports overlaid SSB for LP-SS. Aspects of the signaling diagram 200 may be implemented by or may implement aspects of the wireless communications system 100. Aspects of the signaling diagram 200 may be implemented at or implemented by a UE 205 and a network entity 210, which may be examples of the corresponding devices described herein.

Some wireless networks may support “overlaid sequences” for LP-WUS operations. In each ON symbol duration of OOK signals, an overlaid sequence may be transmitted by the network. In each OOK ON symbol, either random phase signals or a preconfigured sequence may be transmitted. For the former, the overlaid sequence may flatten the LP-WUS spectrum for better detection performance in frequency selective channels. For the latter, the overlaid sequence can additionally carry the LP-WUS information. The overlaid sequence may have similar properties to OFDM signals, such as full bandwidth transmission in the allocated LP-WUS bandwidth, higher sampling rate with respect to the OOK symbol rate, and a relatively flat spectrum. The overlaid sequence may or may not be generated by OFDM modulation with inverse fast Fourier transform (IFFT) processing. In some cases, the overlaid sequence may not change the non-coherent envelope detection of the OOK modulated LP-WUS. In some cases, an in-phase quadrature (IQ) receiver-based LP-WUR may detect the overlaid sequence in the time domain without FFT or in the frequency domain with FFT. The IQ receiver may have a lower noise floor and higher processing gain due to coherent detection than the OOK based receiver. The information data rate of the overlaid sequences can be higher than the OOK signals when the two achieve similar coverage.

In some cases, a LP-SS may be used for synchronization and radio resource management (RRM) measurement(s). For nearby cells, different LP-SSs may be transmitted so that the low-power wakeup ratio (LP-WUR) does not synchronize to a neighbor cell's downlink timing or for the RRM measurements to not be impacted. In some cases, a maximum number of binary sequences may be configured for the LP-SS, such as three for an ideal topology, four based on a four color theorem, or eight or sixteen if the LP-SS can be detected in the non-nearest neighbors. The binary LP-SS sequence may be down-selected from the following: a gold sequence, M sequence, or a computer searched sequence. Similar to the LP-WUS, an overlaid sequence can be transmitted during the on duration of the LP-SS. The overlaid sequence may be also cell specific, in some examples.

In some aspects, an OFDM based LP-WUR may receive the overlaid OFDM sequences of the LP-SS for synchronization and RRM measurements. The OFDM based LP-WUR can also process a primary synchronization signal/secondary synchronization signal (PSS/SSS) from an SSB. The LP-SS periodicity (e.g., 320 ms) may be much longer than that of SSB periodicity (e.g., 20 ms). In some cases, it may not be critical to rely on the LP-SS overlaid sequences if the SSB is configured within the bandwidth of the LP-WUS and the LP-SS. If the SSB is configured within the LP-WUS/LP-SS bandwidth, there may be no need to define the synchronization and RRM measurement performance requirements for the LP-SS overlaid sequences. From an implementation perspective, it may be preferrable to use the same type of overlaid OFDM sequences for LP-WUS and LP-SS. Similar to the LP-WUS, an overlaid sequence can be transmitted at least for spectrum flattening. The overlaid sequence may be also cell specific.

Thus, in some wireless networks the “overlaid sequences” in LP-SS may provide the flexibility for UE implementation of the LP-WUR to achieve a trade-off between power consumption and measurement reliability. The IQ based LP-WUR has lower noise floor and higher processing gain due to coherent detection than the OOK based receiver. The IQ based LP-WUR may receive the overlaid OFDM sequences of the LP-SS for synchronization and RRM measurements. The IQ based LP-WUR can also process PSS/SSS from SSB. Transmitting both the PSS/SSS from the SSB and the LP-SS may cause extra resource overhead and extra network energy consumption, since both serve the purpose of synchronization and RRM measurement.

Accordingly, the techniques described herein provide for an “overlaid SSB” for LP-SS. The overlaid SSB may be transmitted in OOK ON symbols of the LP-SS. In some cases, the overlaid SSB may also be transmitted in the OOK ON symbols of the LP-WUS. However, since LP-WUS may not always be transmitted, the network cannot regularly transmit the overlaid SSB. In other words, because both the LP-SS and the SSB are broadcast signals, it may be more beneficial to bundle these two in the same transmission. Aspects of these techniques may be used to fully replace the SSB in some wireless networks or as a supplementary SSB transmission scheme (e.g., for non-cell defining (NCD)-SSB transmissions in bandwidth where cell defining (CD)-SSB transmissions are not available). The functionality of the NCD-SSB may be more beneficial, such as for the Reduced Capability (RedCap) UE which may benefit more from LP-WUR power savings.

For example, at 215 the network entity 210 may transmit or otherwise output (and the UE 205 may receive or otherwise obtain) a first portion of a signal that is overlaid (e.g., overlaps in a time domain) with a first set of OOK ON symbols of a LP-SS. The first portion of the signal may be associated with synchronization and/or channel measurements. That is, the UE 205 may use the first portion of the signal to perform various synchronization operations and/or various channel measurements.

At 220, the network entity 210 may transmit or otherwise output (and the UE 205 may receive or otherwise obtain) a second portion of the signal that is overlaid with (e.g., overlaps in a time domain) with a second set of OOK ON symbols of the LP-SS. In some cases, the first portion of the signal, the second portion of the signal, or both portions of the signal may be an SSB signal. In some aspects, the first portion of the signal, the second portion of the signal, or both portions of the signal being overlaid with the LP-SS may include two waveforms during the overlap duration. That is, these signals being overlaid may include the content of at least some of the OOK ON symbols being SSB transmissions. Accordingly, at 225 the UE 205 and the network entity 210 may communicate or otherwise exchange various message(s) based on the SSB signal.

For example, in the beginning part of the LP-SS duration (e.g., during the first set of OOK ON symbols), known overlaid sequences may be transmitted in or during the OOK ON symbols. This may include an overlaid sequence for the LP-SS transmission. In some examples, the IQ based LP-WUR of the UE 205 may use these overlaid synchronization sequences for improved time and/or frequency synchronization accuracy and/or RRM measurements relative to that of the OOK based LP-WUR. The overlaid synchronization sequence may also be omitted from the OOK LP-SS, in some cases. That is, in some cases the first portion of the signal transmitted during the first set of OOK ON symbols may be other signaling (e.g., rather than an SSB transmission). In this situation, the LP-WUR (e.g., both OOK based and IQ based receivers) may use the binary sequence of the OOK envelope for synchronization and RRM measurements.

In some cases, the overlaid physical broadcast channel (PBCH), which may include PBCH DMRS, may be transmitted after the overlaid sync sequence (e.g., during the second set of OOK ON symbols), if overlaid sync sequence is transmitted. That is, the PBCH portion of the SSB may be transmitted as the second portion of the signal that is overlaid with the LP-SS during the OOK ON symbols, in some cases. Otherwise, the overlaid PBCH may be transmitted from the start of the LP-SS (e.g., during both the first set of OOK ON symbols and the second set of OOK ON symbols). For this case, after the PBCH is successfully decoded, the UE 205 may regenerate the encoded PBCH payload and use it as the known overlaid synchronization sequence to refine the time and/or frequency estimation and RRM measurements obtained from the OOK envelope.

Accordingly, aspects of the described techniques combine the LP-SS and the SSB in the same signal to support the UE 205 to be able to use the OOK based LP-WUR to acquire synchronization signals while operating in a low power mode. The SSB payload may be transmitted under OOK ON symbols of the OOK envelope. This may enable networks to avoid additional resource usage that is dedicated for legacy SSB transmissions. The described technique may use the main radio of the UE 205 which is an OFDM receiver to detect the PBCH payload when the synchronization signal is acquired first, which consumes the majority of the UE's operating power. Thus, detection of the LP-SSB can consume less power.

In some cases, the LP-SSB may have OOK structure. The OOK receiver of the UE 205 may be used for frequent synchronization signal detection. Once the synchronization signal is detected, the OFDM based main radio of the UE 205 may be turned on to detect the PBCH payload. For the PBCH payload, DMRS transmission may still be used to assist channel estimation operations for the OFDM based main radio of the UE 205. The PBCH payload may be transmitted in OOK ON symbols. The overall LP-SSB transmission may consume more resources for an OOK detector to acquire the synchronization signal. However, the amount of resources allocated for PBCH payload transmission may not be increased.

In some aspects, example use cases for energy saving operations are described. One such use case may include the PBCH binge associated with a lean SSB configuration, or NCD-SSB, which may be mainly used for channel measurements instead of cell search. Therefore, this approach may have a smaller payload size than CD-SSB, which requires less resources than SSB (e.g., if using the same MCS as CD-SSB), or more robust for channel estimation operations (e.g., if using the same sources but with a lower MCS than CD-SSB). The LP-SS may be jointly configured with the overlaid PBCH, in some cases. In some examples, the OOK envelope may satisfy the coverage for idle or inactive mode operations of the UE 205, which may include similar performance requirements for the LP-SSB design.

Regarding the frequency location information of the LP-SSB, one option may include a fixed signal structure being specified so that without any prior information the UE 205 may identify the RBs based on (pre)defined LP-SSB center frequencies and RB grids. In some cases, the absence or presence of the overlaid PBCH may be indicated via a system information (SI) message (e.g., associated with CD-SSB), via LP-SS, via paging, or via other signaling means. In some cases, the overlaid PBCH may also be jointly configured with the monitoring occasions of the LP-WUS. In some cases, the waveform and/or sequence of the LP-WUS may carry additional information for the UE 205.

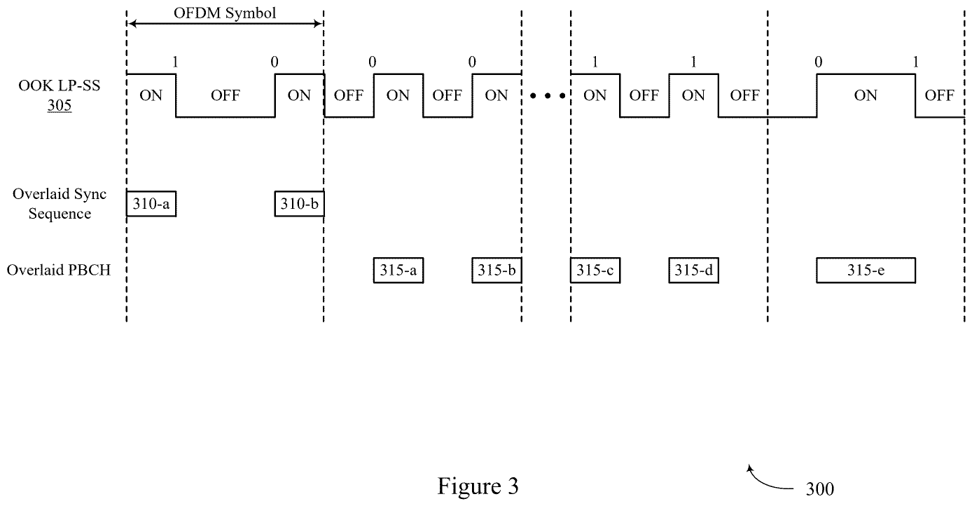

FIG. 3 shows an example of a diagram 300 that supports overlaid SSB for LP-SS. Aspects of the diagram 300 may implement aspects of or be implemented by aspects of the wireless communication system 100 or aspects of the signaling diagram 200. Aspects of the diagram 300 may be implemented at or implemented by a UE or a network entity, which may be examples of the corresponding devices described herein.

As discussed above, the techniques described herein provide for overlaying some or all of an SSB onto a LP-SS 305 to improve wireless communications and power saving operations at the UE and the network entity. For example, the LP-SS 305 may be an OOK-based transmission that includes ON symbols and OFF symbols. The ON symbols may correspond to a waveform being transmitted while the OFF symbols may correspond to no waveform being transmitted. For example, the network entity may transmit and the UE may receive a first portion of a signal during a first set of OOK ON symbols of the LP-SS 305. The first portion of the signal may include an overlaid sequence 310, with an overlaid sequence 310-a being overlaid with respect to a first OOK ON symbol and an overlaid sequence 310-b being overlaid with respect to a second OOK ON symbol. In some cases, the first portion of the signal may be an SSB signal (e.g., a PBCH portion of the SSB signal) or may be a different signal (e.g., a signal that carries sequences or simply a waveform). In some cases, the UE may use the first portion of the signal to perform time and/or frequency synchronization and/or to perform channel measurements.

The network entity may transmit and the UE may receive a second portion of the signal that is overlaid with a second set of OOK ON symbols of the LP-SS 305. As discussed, the first portion of the signal, the second portion of the signal, or both portions of the signal may be an SSB signal. In the example shown the second portion of the signal includes an overlaid PBCH 315. For example, an overlaid PBCH 315-a and an overlaid PBCH 315-b are overlaid with OOK ON symbols during a second OFDM symbol of the LP-SS 305, the overlaid PBCH 315-c and the overlaid PBCH 315-d are overlaid with OOK ON symbols during another OFDM symbol (e.g., OFDM symbol N-1) of the LP-SS 305, and the overlaid PBCH 315-e is overlaid with an OOK ON symbol during a final OFDM symbol (e.g., OFDM symbol N) of the LP-SS 305. In this example, at least the second portion of the signal is a PBCH along with PBCH DMRS that are overlaid with respect to or during the OOK ON symbols of the LP-SS 305.

For example, in the beginning part of the LP-SS duration (e.g., during the first set of OOK ON symbols), known overlaid sequence 310 may be transmitted in or during the OOK ON symbols of the LP-SS 305. That is, the first portion of the signal may include an information sequence (e.g., the overlaid sequence 310) while the second portion of the signal may include the SSB (e.g., the overlaid PBCH 315). This may include an overlaid sequence 310 for the LP-SS transmission. In some examples, the IQ based LP-WUR of the UE may use these overlaid synchronization sequences (e.g., the overlaid sequence 310) for improved time and/or frequency synchronization accuracy and/or RRM measurements relative to that of the OOK based LP-WUR. The overlaid synchronization sequence may also be omitted from the OOK LP-SS, in some cases. That is, in some cases the first portion of the signal transmitted during the first set of OOK ON symbols may be other signaling (e.g., a waveform). In this situation, the LP-WUR (e.g., both OOK based and IQ based receivers) may use the binary sequence of the OOK envelope for synchronization and RRM measurements. That is, in some aspects the first portion of the signal may include signal(s) that are used for synchronization and/or channel measurement operations while the second portion of the signal may include the SSB signal (e.g., the overlaid PBCH 315).

In some cases, the overlaid PBCH 315, which may include PBCH DMRS, may be transmitted after the overlaid sequence 310 (e.g., during the second set of OOK ON symbols), if the overlaid sync sequence is transmitted. In this example the second portion of the signal may include a PBCH portion of the SSB in conjunction with PBCH DMRS signals. That is, the PBCH portion of the SSB may be transmitted as the second portion of the signal that is overlaid with the LP-SS during the OOK ON symbols, in some cases. Otherwise, the overlaid PBCH 315 may be transmitted from the start of the LP-SS (e.g., during both the first set of OOK ON symbols and the second set of OOK ON symbols). For this case, after the PBCH is successfully decoded, the UE may regenerate the encoded PBCH payload and use it as the known overlaid synchronization sequence to refine the time and/or frequency estimation and RRM measurements obtained from the OOK envelope.

In some case, the SSB (e.g., the overlaid PBCH 315) may be transmitted from the start of the LP-SS 305. For example, both the first portion of the signal and the second portion of the signal may include the SSB in some cases. In some cases, the UE may activate an OFDM based LP-WUR or a main radio to receive the second portion of the signal based on the first portion of the signal being received by a LP-WUR of the UE. For example, the UE may use the LP-WUR to acquire the synchronization signal (e.g., the overlaid sequence 310) and, once the synchronization signal is detected, the UE may switch on the OFDM based LP-WUR or the main radio to receive the OFDM modulated PBCH (e.g., the overlaid PBCH 315).

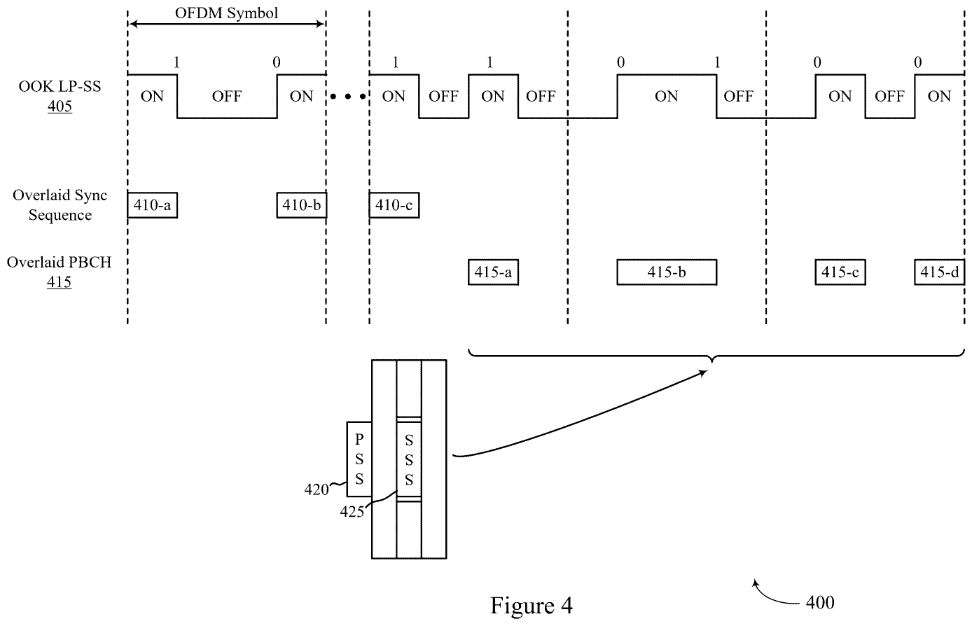

FIG. 4 shows an example of a diagram 400 that supports overlaid SSB for LP-SS. Aspects of the diagram 400 may implement aspects of or be implemented by aspects of the wireless communication system 100 or aspects of the signaling diagram 200. Aspects of the diagram 400 may be implemented at or implemented by a UE or a network entity, which may be examples of the corresponding devices described herein.

As discussed above, the techniques described herein provide for overlaying some or all of an SSB onto a LP-SS 405 to improve wireless communications and power saving operations at the UE and the network entity. For example, the LP-SS 405 may be an OOK-based transmission that includes ON symbols and OFF symbols. For example, the network entity may transmit and the UE may receive a first portion of a signal during a first set of OOK ON symbols of the LP-SS 405. The first portion of the signal may include an overlaid sequence 410, with an overlaid sequence 410-a being overlaid with respect to a first OOK ON symbol, an overlaid sequence 410-b being overlaid with respect to a second OOK ON symbol, and an overlaid sequence 410-c being overlaid with respect to a third OOK ON symbol. In some cases, the first portion of the signal may be an SSB signal (e.g., a PBCH portion of the SSB signal) or may be a different signal (e.g., a signal that carries sequences or simply a waveform). In some cases, the UE may use the first portion of the signal to perform time and/or frequency synchronization and/or to perform channel measurements.

The network entity may transmit and the UE may receive a second portion of the signal that is overlaid with a second set of OOK ON symbols of the LP-SS 405. As discussed, the first portion of the signal, the second portion of the signal, or both portions of the signal may be an SSB signal. In the example shown the second portion of the signal includes an overlaid PBCH 415. For example, an overlaid PBCH 415-a may be overlaid with an OOK ON symbol during an OFDM symbol of the LP-SS 405, an overlaid PBCH 415-b may be overlaid with OOK ON symbols during a next OFDM symbol of the LP-SS 405, an overlaid PBCH 415-c and an overlaid PBCH 415-d are overlaid with OOK ON symbols during final OFDM symbol of the LP-SS 405. In this example, at least the second portion of the signal is a PBCH along with PBCH DMRS that are overlaid with respect to or during the OOK ON symbols of the LP-SS 405.

In this example, the design of the overlaid signals may include a signal structure. This may include a partial cell identifier being modulated onto the OOK envelope of the entire LP-SSB (e.g., the physical cell identifier (PCID) modulus N). Additional cell identifier information may be modulated onto the OFDM sequences in part of the LP-SSB in OOK ON symbols of the LP-SSB. For example, a firs part of the cell identifier may be modulated onto the OOK envelope of the LP-SS 405 while the overlaid sequence 410 (e.g., an overlaid OFDM sequence) may carry additional information relating to the cell identifier. In some aspects, the PBCH payload may be overlaid in the following OOK ON symbols of the LP-SSB (e.g., the overlaid PBCH 415). For example, there may be a mapping from the PBCH of the NR SSB to the LP-SSB PBCH payload. This mapping may include the PSS 420 and the SSS 425 (e.g., the NR SSB) being mapped onto the overlaid PBCH 415 of the second portion of the signal where the signal includes the SSB (e.g., the PBCH payload and the PBCH DMRS transmissions).

In some cases, the OOK envelope of the PBCH payload may be modulated with a known OOK sequence in addition to the LP-SS 405. In some cases, the remaining cell identifier information may be omitted from the LP-SSB (e.g., the overlaid PBCH 415). As discussed, in some cases the UE may acquire the overlaid sequence 410 with its LP-WUR while operating in a low-power mode and, once the overlaid sequence 410 is detected, the UE may switch to an OFDM based LP-WUR or its main radio to receive the OFDM modulated PBCH (e.g., the overlaid PBCH 415).

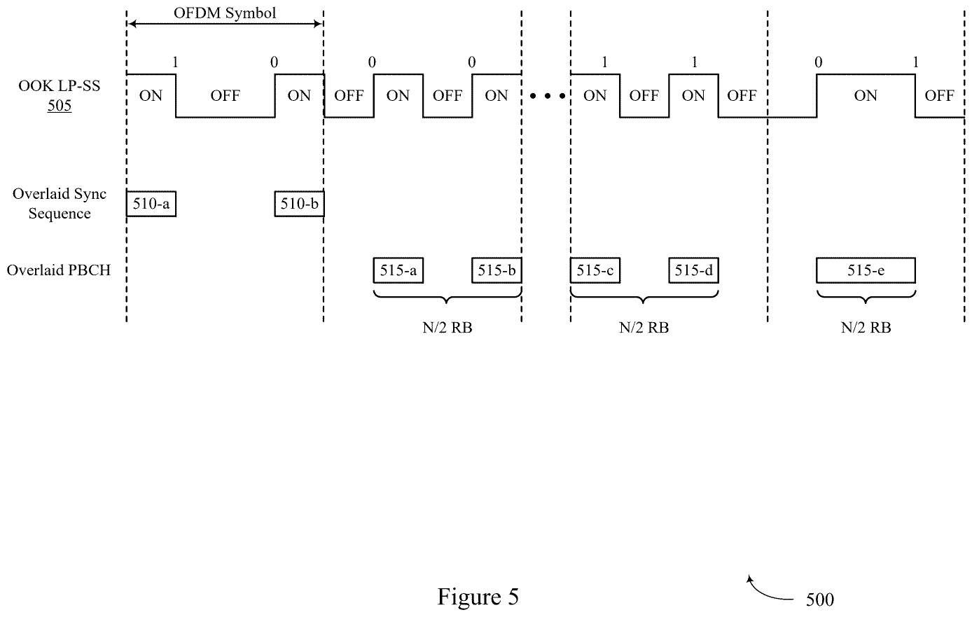

FIG. 5 shows an example of a diagram 500 that supports overlaid SSB for LP-SS. Aspects of the diagram 500 may implement aspects of or be implemented by aspects of the wireless communication system 100 or aspects of the signaling diagram 200. Aspects of the diagram 500 may be implemented at or implemented by a UE or a network entity, which may be examples of the corresponding devices described herein.

As discussed above, the techniques described herein provide for overlaying some or all of an SSB onto a LP-SS 505 to improve wireless communications and power saving operations at the UE and the network entity. For example, the LP-SS 505 may be an OOK-based transmission that includes ON symbols and OFF symbols. For example, the network entity may transmit and the UE may receive a first portion of a signal during a first set of OOK ON symbols of the LP-SS 505. The first portion of the signal may include an overlaid sequence 510, with an overlaid sequence 510-a being overlaid with respect to a first OOK ON symbol and an overlaid sequence 510-b being overlaid with respect to a second OOK ON symbol. In some cases, the first portion of the signal may be an SSB signal (e.g., a PBCH portion of the SSB signal) or may be a different signal (e.g., a signal that carries sequences or simply a waveform). In some cases, the UE may use the first portion of the signal to perform time and/or frequency synchronization and/or to perform channel measurements.

The network entity may transmit and the UE may receive a second portion of the signal that is overlaid with a second set of OOK ON symbols of the LP-SS 505. As discussed, the first portion of the signal, the second portion of the signal, or both portions of the signal may be an SSB signal. In the example shown the second portion of the signal includes an overlaid PBCH 515. For example, an overlaid PBCH 515-a and an overlaid PBCH 515-b may be overlaid with OOK ON symbols during an OFDM symbol of the LP-SS 505, an overlaid PBCH 515-c and an overlaid PBCH 515-d may be overlaid with OOK ON symbols during a next OFDM symbol of the LP-SS 505, and an overlaid PBCH 515-e may be overlaid with OOK ON symbols during final OFDM symbol of the LP-SS 505. In this example, at least the second portion of the signal is a PBCH along with PBCH DMRS that are overlaid with respect to or during the OOK ON symbols of the LP-SS 505.

The diagram 500 illustrates an example where the RB size associated with an OFDM symbols may span multiple OOK ON symbols. The RB size may be a fixed RB size that based on at least the second portion of the signal being overlaid with the LP-SS 505 symbols. That is, the RB may be defined as a resource group with 12 resource elements (REs) and one OFDM symbol. For example, a PBCH may contain 48 RBs. For the joint PBCH and OOK LP-SS design, the PBCH RB size (e.g., the RB size of the overlaid PBCH 515) may be fixed or otherwise (pre)defined to reduce the UE complexity. In some cases, it may be better to have a unified PBCH RB size across the overlaid PBCH 515 and the regular PBCH in the SSB signal. The LP-SS 505 design may meet or otherwise satisfy a minimum required number of OFDM symbols to carry the PBCH RB. For the LP-SS 505 design with a balanced numbers of OOK ON and OFF symbols, each OFDM symbol may provide the resources equal to N/2 RBs where N is the number of RBs allocated for the LP-SS 505 without guard RBs. For example, the overlaid PBCH 515-a and the overlaid PBCH 515-b may be allocated or otherwise correspond to N/2 RBs, the overlaid PBCH 515-c and the overlaid PBCH 515-d may be allocated or otherwise correspond to N/2 RBs, and the overlaid PBCH 515-e may be allocated or otherwise correspond to N/2 RBs. For the LP-SS 505 transmitted in a 5 MHz channel bandwidth having a SCS of 30kHz, 11 RBs may be allocated to the LP-SS 505 excluding the guard RBs. This may use nine OFDM symbols to transmit the overlaid PBCH (e.g., if the total number of RBs for PBCH is 48). In some cases, this may be useful for a 5 MHz channel bandwidth where the SSB cannot be transmitted.

When the bandwidth of the LP-SS 505 (e.g., excluding guard RB(s)) has an odd number of RBs (e.g., when 11 RBs are allocated to the LP-SS 505), there may be extra REs that do not carry PBCH. Accordingly, in some cases the UE may identify or otherwise determine at least one RB associated with the second portion of the signal that does not include the SSB signal and apply an RB utilization scheme based on the at least one RB not including or having the SSB signal. Different RB utilization schemes may be applied by the UE for the extra RB (e.g., the RB that is not used to carry the overlaid PBCH 515).

One scheme may include, in either the beginning or the ending OOK ON duration that carries PBCH, the extra REs/RBs are punctured. That is, the RB utilization scheme in this example may include puncturing at least one RB. Another scheme may include, in either the beginning or ending OOK ON duration that carries PBCH, the extra REs/RBs are used to carry extra PBCH DMRS REs. That is, the RB utilization scheme in this example may include transmitting DMRS associated with the SSB signal.

Another scheme may include, in either the beginning or the ending OOK ON duration that carries PBCH, the extra REs/RBs are used to carry an overlaid synchronization sequence. That is, the RB utilization scheme in this example may include transmitting an information sequence in the at least one RB. Another scheme may include, in either the beginning or the ending OOK ON duration that carries PBCH, the extra REs/RBs are used to carry a PBCH payload. That is, the RB utilization scheme in this example may include configuring the at least one RB to include at least a portion of a payload of the SSB signal (e.g., the PBCH payload). In some cases, there may be some partial PBCH repetition, or a new PBCH payload size defined for this example. In some cases, one or more of the RB utilization schemes may be (pre)defined or otherwise known to the UE and the network entity.

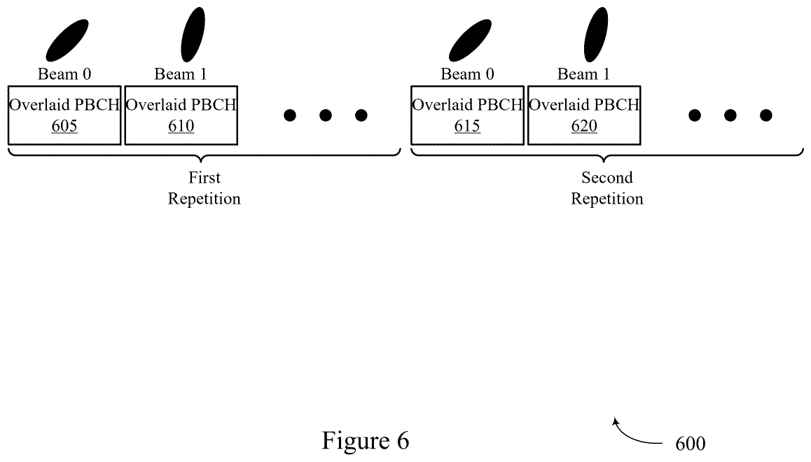

FIG. 6 shows an example of a diagram 600 that supports overlaid SSB for LP-SS. Aspects of the diagram 600 may implement aspects of or be implemented by aspects of the wireless communication system 100 or aspects of the signaling diagram 200. Aspects of the diagram 600 may be implemented at or implemented by a UE or a network entity, which may be examples of the corresponding devices described herein.

As discussed above, the techniques described herein provide for overlaying some or all of an SSB onto a LP-SS to improve wireless communications and power saving operations at the UE and the network entity. For example, the LP-SS may be an OOK-based transmission that includes ON symbols and OFF symbols. For example, the network entity may transmit and the UE may receive a first portion of a signal during a first set of OOK ON symbols of the LP-SS. The first portion of the signal may include an overlaid sequence. In some cases, the first portion of the signal may be an SSB signal (e.g., a PBCH portion of the SSB signal) or may be a different signal (e.g., a signal that carries sequences or simply a waveform). In some cases, the UE may use the first portion of the signal to perform time and/or frequency synchronization and/or to perform channel measurements.

The network entity may transmit and the UE may receive a second portion of the signal that is overlaid with a second set of OOK ON symbols of the LP-SS. As discussed, the first portion of the signal, the second portion of the signal, or both portions of the signal may be an SSB signal. In some cases, the second portion of the signal includes an overlaid PBCH. In this example, at least the second portion of the signal is a PBCH along with PBCH DMRS that are overlaid with respect to or during the OOK ON symbols of the LP-SS.

In some cases, the wireless communications between the UE and the network entity may be beam-based wireless communications (e.g., multi-beam operations). In some cases, this may mean that the first portion of the signal and the second portion of the signal are transmitted with a same transmit beam as is used for the LP-SS transmission. In some examples, both the LP-SS and SSB signal may be transmitted in multiple beam directions. For the overlaid PBCH design, the overlaid PBCH and the LP-SS may be transmitted in the same beam at a time. This may mean that the overlaid PBCH and the LP-SS have a one-to-one beam association relationship (e.g., QCL-D association). If the overlaid PBCH is transmitted from the same beams as is used for the SSB signal, the LP-SS may also be transmitted in each SSB beam. The LP-SS with the overlaid PBCH may have a multi-beam sweep pattern that includes the overlaid PBCH 605 being transmitted using beam 0 and the overlaid PBCH 610 being transmitted using beam 1 during a first repetition while the overlaid PBCH 615 may be transmitted using beam 0 and the overlaid PBCH 620 may be transmitted using beam 1 during a second repetition.

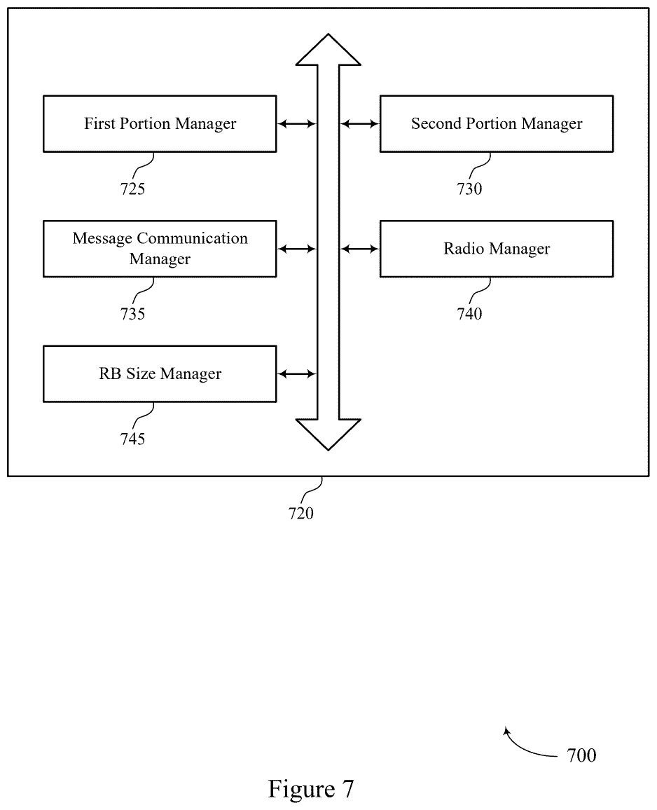

FIG. 7 shows an example of a processing system 720 that supports overlaid SSB for LP-SS. A processing system 720 may be an example of a processing system 140 (such as of a UE 115) and may include a first portion manager 725, a second portion manager 730, a message communication manager 735, a radio manager 740, an RB size manager 745, or any combination thereof. A processing system 720, or various component thereof, may be an example of means for performing (such as a means for causing a UE 115 to perform) various techniques described herein.

The first portion manager 725 may be configured to cause the UE 115 to receive, from a network entity, a first portion of a signal that is overlaid with a first set of OOK on symbols of a LP-SS, the first portion of the signal being associated with synchronization, channel measurement, or both. The second portion manager 730 may be configured to cause the UE 115 to receive, from the network entity, a second portion of the signal that is overlaid with a second set of OOK on symbols of the LP-SS, where the first portion of the signal, the second portion of the signal, or both, include a SSB signal. The message communication manager 735 may be configured to cause the UE 115 to communicate one or more messages with the network entity based on the SSB signal.

In some examples, the radio manager 740 may be configured to cause the UE 115 to activate an OFDM based LP-WUR or a main radio of the UE to receive the second portion of the signal based on the first portion of the signal being received by a LP-WUR of the UE.

In some examples, an RB size associated with an OFDM symbol spanning multiple OOK on symbols includes a fixed RB size based on at least the second portion of the signal being overlaid with the LP-SS on symbols. In some examples, the RB size manager 745 may be configured to cause the UE 115 to identify at least one RB associated with the second portion of the signal that does not include the SSB signal. In some examples, the RB size manager 745 may be configured to cause the UE 115 to apply an RB utilization scheme based on the identified at least one RB.

In some examples, to support application of the RB utilization scheme, the RB size manager 745 may be configured to cause the UE 115 to puncture the at least one RB, transmit DMRS associated with the SSB signal, transmit an information sequence in the at least one RB, or configure the at least one RB to include at least a portion of a payload of the SSB signal. In some examples, the first portion of the signal includes an information sequence and the second portion of the signal includes the SSB signal. In some examples, the second portion of the signal includes a PBCH portion of the SSB signal in conjunction with one or more PBCH DMRS signals. In some examples, the first portion of the signal includes one or more signals available for the synchronization, channel measurement, or both, and the second portion of the signal includes the SSB signal. In some examples, both the first portion of the signal and the second portion of the signal include the SSB signal. In some examples, the first portion of the signal and the second portion of the signal are associated with a same transmit beam used for LP-SS transmission.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for improved power saving operations and wireless communications by overlaying at least a portion of an SSB signal onto a LP-SS that the UE monitors while operating in the low power mode.

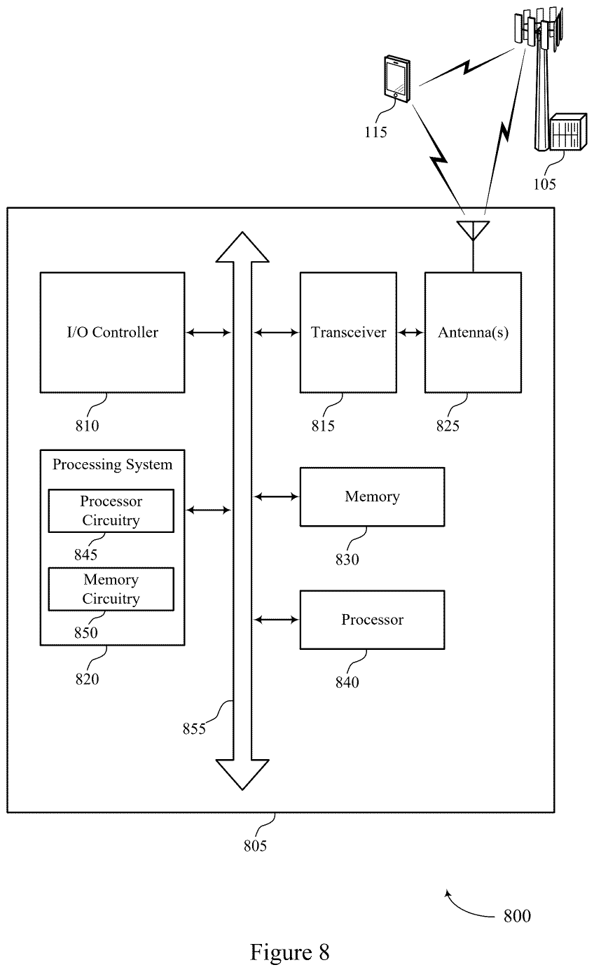

FIG. 8 shows an example of a system 800 including a device 805 that supports overlaid SSB for LP-SS. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 700. For example, the processing system 820 may include processor circuitry 845 and memory circuitry 850 that stores code, and may be configured to cause the device 805 to perform operations that support overlaid SSB for LP-SS. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, may support techniques for improved power saving operations and wireless communications by overlaying at least a portion of an SSB signal onto a LP-SS that the UE monitors while operating in the low power mode.

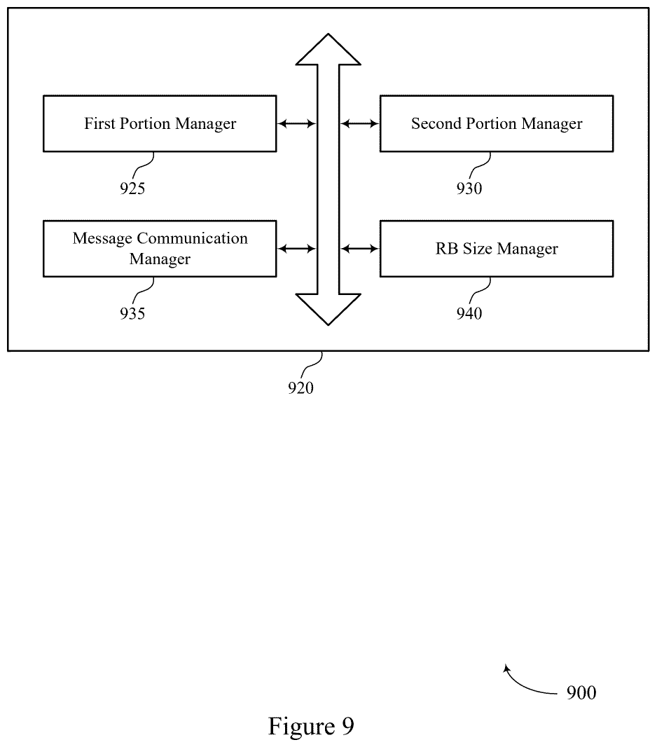

FIG. 9 shows an example of a processing system 920 that supports overlaid SSB for LP-SS. A processing system 920 may be an example of a processing system 145 (such as network entity 105) and may include a first portion manager 925, a second portion manager 930, a message communication manager 935, an RB size manager 940, or any combination thereof. A processing system 920, or various component thereof, may be an example of means for performing (such as a means for causing a network entity 105 to perform) various techniques described herein.

The first portion manager 925 may be configured to cause the network entity 105 to output, to a UE, a first portion of a signal that is overlaid with a first set of OOK on symbols of a LP-SS, the first portion of the signal being associated with synchronization, channel measurement, or both. The second portion manager 930 may be configured to cause the network entity 105 to output, to the UE, a second portion of the signal that is overlaid with a second set of OOK on symbols of the LP-SS, where the first portion of the signal, the second portion of the signal, or both, include a SSB signal. The message communication manager 935 may be configured to cause the network entity 105 to communicate one or more messages with the UE based on the SSB signal.

In some examples, the first portion of the signal includes an information sequence and the second portion of the signal includes the SSB signal. In some examples, the second portion of the signal includes a PBCH portion of the SSB signal in conjunction with one or more PBCH DMRS signals. In some examples, the first portion of the signal includes one or more signals available for the synchronization, channel measurement, or both, and the second portion of the signal includes the SSB signal.

In some examples, the RB size manager 940 may be configured to cause the network entity 105 to identify at least one RB associated with the second portion of the signal that does not include the SSB signal. In some examples, the RB size manager 940 may be configured to cause the network entity 105 to apply an RB utilization scheme based on the identified at least one RB.

In some examples, to support application of the RB utilization scheme, the RB size manager 940 may be configured to cause the network entity 105 to puncture the at least one RB, transmit DMRS associated with the SSB signal, transmit an information sequence in the at least one RB, or configure the at least one RB to include at least a portion of a payload of the SSB signal. In some examples, both the first portion of the signal and the second portion of the signal include the SSB signal. In some examples, an RB size associated with an OFDM symbol spanning multiple OOK on symbols includes a fixed RB size based on at least the second portion of the signal being overlaid with the LP-SS on symbols. In some examples, the first portion of the signal and the second portion of the signal are associated with a same transmit beam used for LP-SS transmission.

A processing system 920 may include or be an example of one or more chips, SoCs, chipsets, packages, components, or devices that individually or collectively constitute or include a processing system. A processing system 920 may interface with other components of a network entity 105. For example, operations described with reference to a processing system 920, or various components thereof, may be performed by or with other such components, including a receiver, a transmitter, a transceiver, a modem, a user interface, a modulator/demodulator, an encoder/decoder, or any combination thereof (such as of the processing system 920, coupled with the processing system 920, of a network entity 105). Operations described herein with reference to the processing system 920, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 920 for operation in a processing system 920 as described herein, the processing system 920 may support techniques for improved power saving operations and wireless communications by overlaying at least a portion of an SSB signal onto a LP-SS that the UE monitors while operating in the low power mode.

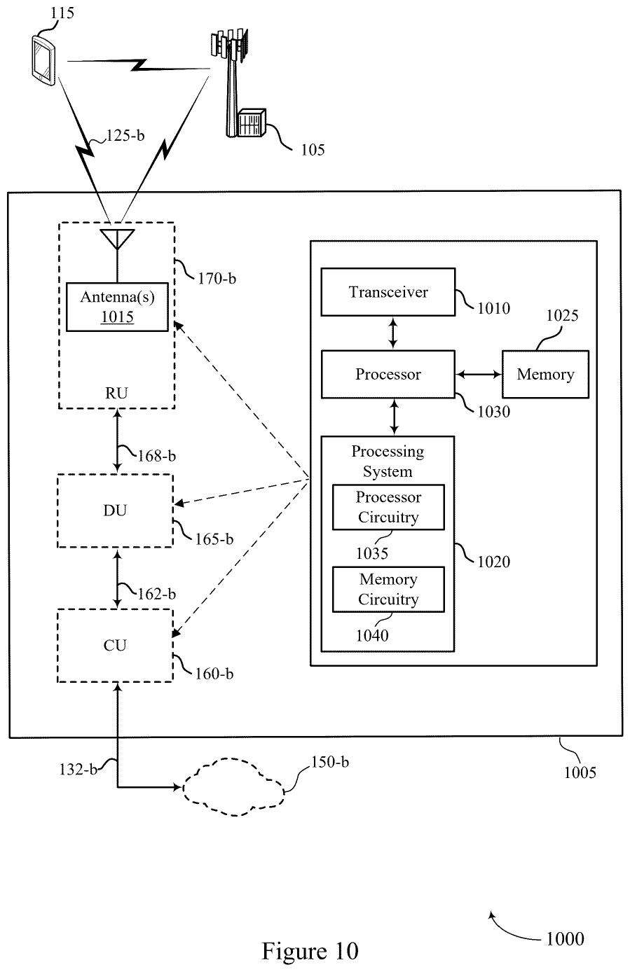

FIG. 10 shows an example of a system 1000 including a device 1005 that supports overlaid SSB for LP-SS. The device 1005 may communicate (such as via one or more wired interfaces or one or more wireless interfaces) with other network devices or network equipment such as a core network 150-b, other network entities 105, UEs 115, or any combination thereof. The device 1005 may include components for transmitting and receiving communication, which may include a processing system 1020, a transceiver 1010, antenna(s) 1015, a memory 1025, and a processor 1030. Components of the device 1005 may be coupled (such as operatively, communicatively, functionally, electronically, electrically, in electronic communication) via one or more interfaces.

The transceiver 1010 may communicate bi-directionally with another transceiver via wired or wireless links, and may support transmission operations, reception operations, or both, as described herein. The transceiver 1010 may include a modem to modulate and demodulate signals, to provide the modulated signals for transmission (such as via antenna(s) 1015, via a wired interface), and to demodulate received signals (such as received via antenna(s) 1015, received via a wired interface). The transceiver 1010 may be operable to support communication via one or more communication links (such as a communication link 125-b, a backhaul link 132-b, a midhaul link 162-b, fronthaul link 168-b).

The processor 1030 may be a general-purpose processing component that supports various operations (such as applications) of the device 1005. The memory 1025 may be a general-purpose storage component that stores code executable by the processor 1030. Such code may include instructions that, when executed by the processor 1030, cause the device 1005 to perform various functions (such as to support an application of the device 1005).

For examples in which the device 1005 is a network entity 105 in a disaggregated architecture, one or more components of the device 1005 may be located at one or more of a CU 160-b, a DU 165-b, or an RU 170-b, one or more of which may include aspects of the processing system 1020, the processor 1030, the memory 1025, or the transceiver 1010. Functions of the device 1005 may be performed at different components or an operation may be divided between different components (such as different functions being supported by aspects of the CU 160-b, the DU 165-b, or the RU 170-b, the transceiver 1010, the processor 1030, the memory 1025, the processing system 1020, or any combination thereof). For example, the processing system 1020 may be a component of one or more of the CU 160-b, the DU 165-b, or the RU 170-b. In some examples, interfaces between components of device 1005 (such as CU 160-b, DU 165-b, RU 170-b) may support communication at a protocol layer or between protocol layers of a protocol stack.

In some examples, the processing system 1020 may manage aspects of communication with the core network 150-b (such as via a backhaul link 132). For example, the processing system 1020 may manage the transfer of data communication for UEs 115 with a gateway of the core network 150-b. In some examples, the processing system 1020 may manage communication with one or more other network entities 105 and may include a controller or scheduler for controlling communication with UEs 115 (such as in cooperation with the one or more other network entities 105). In some examples, the processing system 1020 may support an interface (such as X2 interface, Xn interface) to provide communication between network entities 105.

The processing system 1020 may be an example of a processing system 145 or a processing system 900. For example, the processing system 1020 may include processor circuitry 1035 and memory circuitry 1040 that stores code, and the processing system 1020 may be configured to cause the device 1005 to perform operations that support overlaid SSB for LP-SS. Although the processing system 1020 is illustrated as a separate component, which may involve a separate chip, chipset, or other module, in some implementations, one or more functions described with reference to the processing system 1020 may be supported by or performed by a transceiver 1010, antenna(s) 1015, a processor 1030, memory 1025, or any combination thereof, such that a processing system 1020 may include one or more of a transceiver 1010, antenna(s) 1015, a processor 1030, memory 1025, or any combination thereof. Further, processor circuitry 1035 and memory circuitry 1040 each may be implemented at the device 1005 in accordance with an aggregated architecture, or the processor circuitry 1035 and the memory circuitry 1040 may be implemented at one or more of a CU 160-b, a DU 165-b, or an RU 170-b in accordance with a disaggregated architecture.

By including or configuring the processing system 1020 for operation in the device 1005 as described herein, may support techniques for improved power saving operations and wireless communications by overlaying at least a portion of an SSB signal onto a LP-SS that the UE monitors while operating in the low power mode.

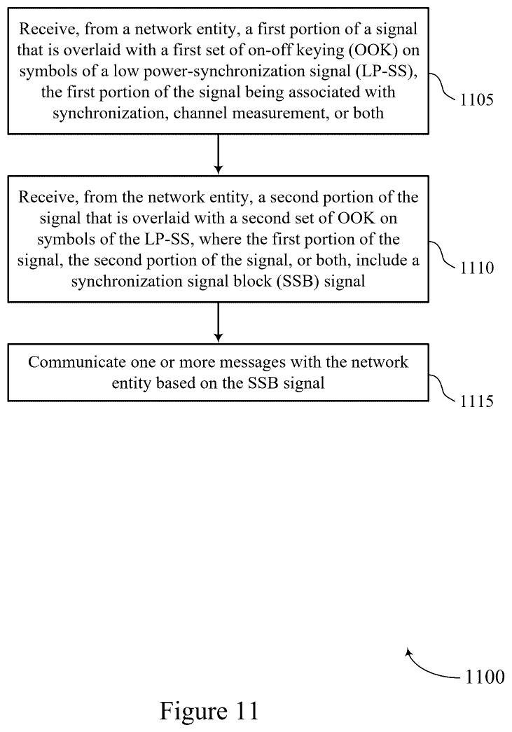

FIG. 11 shows an example of a method 1100 that supports overlaid SSB for LP-SS. Operations of the method 1100 may be performed by a UE or its components (such as using a processing system configured to cause the UE 115 to perform one or more of the operations) as described herein.

At 1105, the method may include receiving, from a network entity, a first portion of a signal that is overlaid with a first set of OOK on symbols of a LP-SS, the first portion of the signal being associated with synchronization, channel measurement, or both. In some examples, aspects of the operations of 1105 may be performed by a first portion manager 725.

At 1110, the method may include receiving, from the network entity, a second portion of the signal that is overlaid with a second set of OOK on symbols of the LP-SS, where the first portion of the signal, the second portion of the signal, or both, include a SSB signal. In some examples, aspects of the operations of 1110 may be performed by a second portion manager 730.

At 1115, the method may include communicating one or more messages with the network entity based on the SSB signal. In some examples, aspects of the operations of 1115 may be performed by a message communication manager 735.

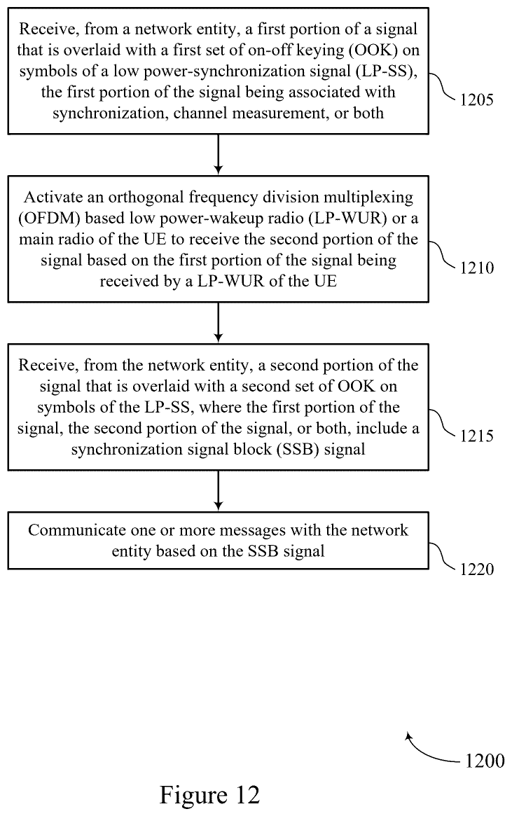

FIG. 12 shows an example of a method 1200 that supports overlaid SSB for LP-SS. Operations of the method 1200 may be performed by a UE or its components (such as using a processing system configured to cause the UE 115 to perform one or more of the operations) as described herein.

At 1205, the method may include receiving, from a network entity, a first portion of a signal that is overlaid with a first set of OOK on symbols of a LP-SS, the first portion of the signal being associated with synchronization, channel measurement, or both. In some examples, aspects of the operations of 1205 may be performed by a first portion manager 725.

At 1210, the method may include activating an OFDM based LP-WUR or a main radio of the UE to receive the second portion of the signal based on the first portion of the signal being received by a LP-WUR of the UE. In some examples, aspects of the operations of 1210 may be performed by a radio manager 740.

At 1215, the method may include receiving, from the network entity, a second portion of the signal that is overlaid with a second set of OOK on symbols of the LP-SS, where the first portion of the signal, the second portion of the signal, or both, include a SSB signal. In some examples, aspects of the operations of 1215 may be performed by a second portion manager 730.

At 1220, the method may include communicating one or more messages with the network entity based on the SSB signal. In some examples, aspects of the operations of 1220 may be performed by a message communication manager 735.

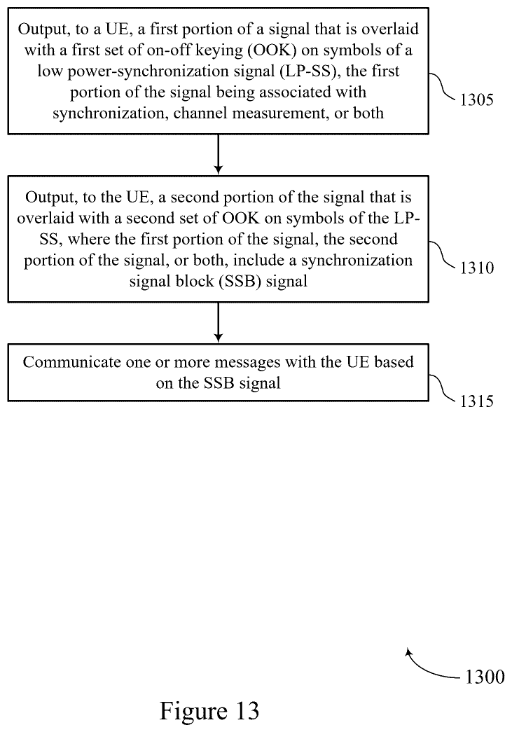

FIG. 13 shows an example of a method 1300 that supports overlaid SSB for LP-SS. Operations of the method 1300 may be performed by a network entity 105 or its components (such as using a processing system configured to cause the network entity to perform one or more operations) as described herein.

At 1305, the method may include outputting, to a UE, a first portion of a signal that is overlaid with a first set of OOK on symbols of a LP-SS, the first portion of the signal being associated with synchronization, channel measurement, or both. In some examples, aspects of the operations of 1305 may be performed by a first portion manager 925.

At 1310, the method may include outputting, to the UE, a second portion of the signal that is overlaid with a second set of OOK on symbols of the LP-SS, where the first portion of the signal, the second portion of the signal, or both, include a SSB signal. In some examples, aspects of the operations of 1310 may be performed by a second portion manager 930.

At 1315, the method may include communicating one or more messages with the UE based on the SSB signal. In some examples, aspects of the operations of 1315 may be performed by a message communication manager 935.
Aspect 1: A method for wireless communications at a UE, comprising: receiving, from a network entity, a first portion of a signal that is overlaid with a first set of OOK on symbols of a LP-SS, the first portion of the signal being associated with synchronization, channel measurement, or both; receiving, from the network entity, a second portion of the signal that is overlaid with a second set of OOK on symbols of the LP-SS, wherein the first portion of the signal, the second portion of the signal, or both, comprise a SSB signal; and communicating one or more messages with the network entity based at least in part on the SSB signal.
Aspect 2: The method of aspect 1, further comprising: activating an OFDM based LP-WUR or a main radio of the UE to receive the second portion of the signal based at least in part on the first portion of the signal being received by a LP-WUR of the UE.
Aspect 3: The method of any of aspects 1 through 2, wherein an RB size associated with an OFDM symbol spanning multiple OOK on symbols comprises a fixed RB size based at least in part on at least the second portion of the signal being overlaid with the LP-SS on symbols.
Aspect 4: The method of aspect 3, further comprising: identifying at least one RB associated with the second portion of the signal that does not include the SSB signal; and applying an RB utilization scheme based at least in part on the identified at least one RB.
Aspect 5: The method of aspect 4, wherein the RB utilization scheme comprises at least one of: puncturing the at least one RB, transmitting DMRS associated with the SSB signal, transmitting an information sequence in the at least one RB, or configuring the at least one RB to include at least a portion of a payload of the SSB signal.
Aspect 6: The method of any of aspects 1 through 5, wherein the first portion of the signal comprises an information sequence and the second portion of the signal comprises the SSB signal.
Aspect 7: The method of aspect 6, wherein the second portion of the signal comprises a PBCH portion of the SSB signal in conjunction with one or more PBCH DMRS signals.
Aspect 8: The method of any of aspects 1 through 7, wherein the first portion of the signal comprises one or more signals available for the synchronization, channel measurement, or both, and the second portion of the signal comprises the SSB signal.
Aspect 9: The method of any of aspects 1 through 8, wherein both the first portion of the signal and the second portion of the signal comprise the SSB signal.
Aspect 10: The method of any of aspects 1 through 9, wherein the first portion of the signal and the second portion of the signal are associated with a same transmit beam used for LP-SS transmission.
Aspect 11: A method for wireless communications at a network entity, comprising: outputting, to a UE, a first portion of a signal that is overlaid with a first set of OOK on symbols of a LP-SS, the first portion of the signal being associated with synchronization, channel measurement, or both; outputting, to the UE, a second portion of the signal that is overlaid with a second set of OOK on symbols of the LP-SS, wherein the first portion of the signal, the second portion of the signal, or both, comprise a SSB signal; and communicating one or more messages with the UE based at least in part on the SSB signal.
Aspect 12: The method of aspect 11, wherein the first portion of the signal comprises an information sequence and the second portion of the signal comprises the SSB signal.
Aspect 13: The method of aspect 12, wherein the second portion of the signal comprises a PBCH portion of the SSB signal in conjunction with one or more PBCH DMRS signals.
Aspect 14: The method of any of aspects 11 through 13, wherein the first portion of the signal comprises one or more signals available for the synchronization, channel measurement, or both, and the second portion of the signal comprises the SSB signal.
Aspect 15: The method of aspect 14, further comprising: identifying at least one RB associated with the second portion of the signal that does not include the SSB signal; and applying an RB utilization scheme based at least in part on the identified at least one RB.
Aspect 16: The method of aspect 15, wherein the RB utilization scheme comprises at least one of: puncturing the at least one RB, transmitting DMRS associated with the SSB signal, transmitting an information sequence in the at least one RB, or configuring the at least one RB to include at least a portion of a payload of the SSB signal.
Aspect 17: The method of any of aspects 11 through 16, wherein both the first portion of the signal and the second portion of the signal comprise the SSB signal.
Aspect 18: The method of any of aspects 11 through 17, wherein an RB size associated with an OFDM symbol spanning multiple OOK on symbols comprises a fixed RB size based at least in part on at least the second portion of the signal being overlaid with the LP-SS on symbols.
Aspect 19: The method of any of aspects 11 through 18, wherein the first portion of the signal and the second portion of the signal are associated with a same transmit beam used for LP-SS transmission.
Aspect 20: A UE for wireless communications, comprising a processing system that includes processor circuitry and memory circuitry that stores code, the processing system configured to cause the UE to perform a method of any of aspects 1 through 10.
Aspect 21: A UE for wireless communications, comprising at least one means for performing a method of any of aspects 1 through 10.
Aspect 22: A non-transitory computer-readable medium storing code for wireless communications, the code comprising instructions executable by one or more processors to perform a method of any of aspects 1 through 10.
Aspect 23: A network entity for wireless communications, comprising a processing system that includes processor circuitry and memory circuitry that stores code, the processing system configured to cause the network entity to perform a method of any of aspects 11 through 19.
Aspect 24: A network entity for wireless communications, comprising at least one means for performing a method of any of aspects 11 through 19.
Aspect 25: A non-transitory computer-readable medium storing code for wireless communications, the code comprising instructions executable by one or more processors to perform a method of any of aspects 11 through 19.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive, from a network entity, a first portion of a signal that is overlaid with a first set of on-off keying (OOK) on symbols of a low power-synchronization signal (LP-SS), the first portion of the signal being associated with synchronization, channel measurement, or both;
receive, from the network entity, a second portion of the signal that is overlaid with a second set of OOK on symbols of the LP-SS, wherein the first portion of the signal, the second portion of the signal, or both, comprise a synchronization signal block (SSB) signal; and
communicate one or more messages with the network entity based at least in part on the SSB signal.

2. The UE of claim 1, wherein the processing system is further configured to cause the UE to:
activate an orthogonal frequency division multiplexing (OFDM) based low power-wakeup radio (LP-WUR) or a main radio of the UE to receive the second portion of the signal based at least in part on the first portion of the signal being received by a LP-WUR of the UE.

3. The UE of claim 1, wherein a resource block (RB) size associated with an OFDM symbol spanning multiple OOK on symbols comprises a fixed RB size based at least in part on at least the second portion of the signal being overlaid with the LP-SS on symbols.

4. The UE of claim 3, wherein the processing system is further configured to cause the UE to:
identify at least one RB associated with the second portion of the signal that does not include the SSB signal; and
apply an RB utilization scheme based at least in part on the identified at least one RB.

5. The UE of claim 4, wherein, to support application of the RB utilization scheme, the processing system is configured to cause the UE to:
puncture the at least one RB, transmit demodulation reference signals (DMRS) associated with the SSB signal, transmit an information sequence in the at least one RB, or configure the at least one RB to include at least a portion of a payload of the SSB signal.

6. The UE of claim 1, wherein the first portion of the signal comprises an information sequence and the second portion of the signal comprises the SSB signal.

7. The UE of claim 6, wherein the second portion of the signal comprises a physical broadcast channel (PBCH) portion of the SSB signal in conjunction with one or more PBCH demodulation reference signal (DMRS) signals.

8. The UE of claim 1, wherein the first portion of the signal comprises one or more signals available for the synchronization, channel measurement, or both, and the second portion of the signal comprises the SSB signal.

9. The UE of claim 1, wherein both the first portion of the signal and the second portion of the signal comprise the SSB signal.

10. The UE of claim 1, wherein the first portion of the signal and the second portion of the signal are associated with a same transmit beam used for LP-SS transmission.

11. A network entity, comprising:
a processing system that includes processor circuitry and memory circuitry that stores code, the processing system configured to cause the network entity to:
output, to a user equipment (UE), a first portion of a signal that is overlaid with a first set of on-off keying (OOK) on symbols of a low power-synchronization signal (LP-SS), the first portion of the signal being associated with synchronization, channel measurement, or both;
output, to the UE, a second portion of the signal that is overlaid with a second set of OOK on symbols of the LP-SS, wherein the first portion of the signal, the second portion of the signal, or both, comprise a synchronization signal block (SSB) signal; and
communicate one or more messages with the UE based at least in part on the SSB signal.

12. The network entity of claim 11, wherein the first portion of the signal comprises an information sequence and the second portion of the signal comprises the SSB signal.

13. The network entity of claim 12, wherein the second portion of the signal comprises a physical broadcast channel (PBCH) portion of the SSB signal in conjunction with one or more PBCH demodulation reference signal (DMRS) signals.

14. The network entity of claim 11, wherein the first portion of the signal comprises one or more signals available for the synchronization, channel measurement, or both, and the second portion of the signal comprises the SSB signal.

15. The network entity of claim 14, wherein the processing system is further configured to cause the network entity to:
identify at least one RB associated with the second portion of the signal that does not include the SSB signal; and
apply an RB utilization scheme based at least in part on the identified at least one RB.

16. The network entity of claim 15, wherein, to support application of the RB utilization scheme, the processing system is configured to cause the network entity to:
puncture the at least one RB, transmit demodulation reference signals (DMRS) associated with the SSB signal, transmit an information sequence in the at least one RB, or configure the at least one RB to include at least a portion of a payload of the SSB signal.

17. The network entity of claim 11, wherein both the first portion of the signal and the second portion of the signal comprise the SSB signal.

18. The network entity of claim 11, wherein a resource block (RB) size associated with an OFDM symbol spanning multiple OOK on symbols comprises a fixed RB size based at least in part on at least the second portion of the signal being overlaid with the LP-SS on symbols.

19. The network entity of claim 11, wherein the first portion of the signal and the second portion of the signal are associated with a same transmit beam used for LP-SS transmission.

20. A method for wireless communications at a user equipment (UE), comprising:
receiving, from a network entity, a first portion of a signal that is overlaid with a first set of on-off keying (OOK) on symbols of a low power-synchronization signal (LP-SS), the first portion of the signal being associated with synchronization, channel measurement, or both;
receiving, from the network entity, a second portion of the signal that is overlaid with a second set of OOK on symbols of the LP-SS, wherein the first portion of the signal, the second portion of the signal, or both, comprise a synchronization signal block (SSB) signal; and
communicating one or more messages with the network entity based at least in part on the SSB signal.

21. The method of claim 20, further comprising:
activating an orthogonal frequency division multiplexing (OFDM) based low power-wakeup radio (LP-WUR) or a main radio of the UE to receive the second portion of the signal based at least in part on the first portion of the signal being received by a LP-WUR of the UE.

22. The method of claim 20, wherein a resource block (RB) size associated with an OFDM symbol spanning multiple OOK on symbols comprises a fixed RB size based at least in part on at least the second portion of the signal being overlaid with the LP-SS on symbols.

23. The method of claim 22, further comprising:
identifying at least one RB associated with the second portion of the signal that does not include the SSB signal; and
applying an RB utilization scheme based at least in part on the identified at least one RB.

24. The method of claim 23, wherein the RB utilization scheme comprises at least one of:
puncturing the at least one RB, transmitting demodulation reference signals (DMRS) associated with the SSB signal, transmitting an information sequence in the at least one RB, or configuring the at least one RB to include at least a portion of a payload of the SSB signal.

25. The method of claim 20, wherein the first portion of the signal comprises an information sequence and the second portion of the signal comprises the SSB signal.

26. The method of claim 25, wherein the second portion of the signal comprises a physical broadcast channel (PBCH) portion of the SSB signal in conjunction with one or more PBCH demodulation reference signal (DMRS) signals.

27. The method of claim 20, wherein the first portion of the signal comprises one or more signals available for the synchronization, channel measurement, or both, and the second portion of the signal comprises the SSB signal.

28. The method of claim 20, wherein both the first portion of the signal and the second portion of the signal comprise the SSB signal.

29. The method of claim 20, wherein the first portion of the signal and the second portion of the signal are associated with a same transmit beam used for LP-SS transmission.

30. A method for wireless communications at a network entity, comprising:
outputting, to a user equipment (UE), a first portion of a signal that is overlaid with a first set of on-off keying (OOK) on symbols of a low power-synchronization signal (LP-SS), the first portion of the signal being associated with synchronization, channel measurement, or both;
outputting, to the UE, a second portion of the signal that is overlaid with a second set of OOK on symbols of the LP-SS, wherein the first portion of the signal, the second portion of the signal, or both, comprise a synchronization signal block (SSB) signal; and
communicating one or more messages with the UE based at least in part on the SSB signal.
